(19) United States
(12) Patent Application Publication
(10) Pub. No.: US 2008/0036805 A1
(43) Pub. Date: Feb. 14, 2008

(54) LIQUID INJECTING METHOD AND LIQUID CONTAINER

(76) Inventors: Satoshi Shinada, Shiojiri-shi (JP); Chiaki Miyajima, Matsumato-Shi (JP); Masahide Matsuyama, Nagano-ken (JP); Yuichi Seki, Matsumoto-shi (JP); Hisashi Koike, Suwa-shi (JP); Takayoshi Katsumura, Matsumoto-shi (JP)

Correspondence Address: SUGHRUE-265550, 2100 PENNSYLVANIA AVE. NW, WASHINGTON, DC, 20037-3213, US

(21) Appl. No.: 11/836,820

(22) Filed: Aug. 10, 2007

(30) Foreign Application Priority Data
Aug. 11, 2006 (JP) P2006-220755
Aug. 12, 2006 (JP) P2006-220772

(51) Int. Cl. B41J 29/38; B41J 2/175

(52) U.S. Cl. 347/9; 347/86

(57) ABSTRACT

A method of injecting a liquid into a liquid container detachably mounted on a liquid consuming device, the liquid container including; a liquid containing portion; a liquid supply portion connectable to the liquid consuming device; a liquid guide passage for guiding the liquid contained in the liquid containing portion to the liquid supply portion; an air communicating passage communicating the liquid containing portion with an air; a first inner wall surface; and a second inner wall surface intersecting with the first inner wall surface, the first inner wall surface having a liquid containing portion outlet formed close to the second inner wall surface and allowing the liquid containing portion to communicate with the liquid guide passage, the method including: forming an injection port communicating with the liquid containing portion in the air communicating passage; injecting a predetermined amount of liquid through the injection port; and sealing the injection port after injecting the liquid.

### BACKGROUND

1. Technical Field

The present invention relates to a method of injecting a liquid in a liquid container of an open-air type that is suitable for an ink cartridge detachable from, for example, an ink jet printer and the like, and the liquid container.

2. Related Art

As an ink cartridge (liquid container) detachable from a liquid consuming device such as an ink jet printer, various kinds of open-air type ink cartridge are suggested. The open-air ink cartridge has, in a container body detachable from a printer, an ink containing portion (liquid containing portion) that contains ink, an ink supply portion (liquid supply portion) that is connected to a printing head (liquid ejecting portion), an ink guide path (liquid guide path) that guides the ink stored in the ink containing portion to the ink supply portion, and an air communicating path that introduces air into the ink containing portion from the outside with a consumption of the ink in the containing portion.

In such an ink cartridge, an ink residual quantity detecting mechanism (liquid detecting unit) in which a sensor having a piezoelectric vibrating body is disposed at a reference height in the liquid containing portion is provided (for example, see Patent Document 1). The liquid level of the ink stored in the liquid containing portion falls to the reference height with consumption by printing and outside air introduced from the air communicating path to the liquid containing portion according to ink consumption reaches a detection position of the sensor. Then, the ink residual quantity detection mechanism outputs different signals between when the periphery of the sensor fills with ink liquid and when the periphery of the sensor comes in contact with the air. The printer detects that the liquid level of the ink falls to the reference height based on the signals (change in residual vibration) output from the ink residual quantity detection mechanism.

That is, a change of acoustic impedance is detected by causing a piezoelectric device having a piezoelectric element or a vibrating portion of an actuator provided in the liquid containing portion to vibrate, subsequently by measuring a counter electromotive force generated by the residual vibration remaining in the vibrating portion, and by detecting an amplitude of a resonance frequency or a counter electromotive force waveform. The detected signal is used to display the residual quantity of ink or give notice of a cartridge replacement time.

Patent Document 1: JP-A-2001-146019

However, an ink cartridge is a container that includes multiple elements and is formed with a high precision. Accordingly, when ink is exhausted, the disposal of the ink cartridge results in a waste of a useful resource and a big economical loss. It is desirable that the used ink cartridge is re-used by re-injecting ink therein.

However, when the known ink cartridge is manufactured, an ink injecting step is included. Accordingly, after the ink cartridge is manufactured, there are many cases where the same ink injecting step cannot be used. As a result, it is necessary to develop a method of injecting ink in order to realize an ink-re-filling, instead of the ink injecting method at the time a new ink cartridge is manufactured.

A recent ink cartridge becomes high performance in that a differential pressure valve that adjusts an ink pressure to be supplied to the ink supply portion and also serves as a check valve for preventing the ink from flowing backward from an ink supply portion or an ink residual quantity detection mechanism for detecting an ink residual quantity is provided in an ink guide path allowing an ink containing chamber to communicate with the ink supply portion. Moreover, a configuration of the ink containing chamber or an air communicating path becomes complicated.

For this reason, if a container body is arranged carelessly, when ink is injected, a poor re-use may be caused. For example, the ink may leak into portions other than the ink containing portion or an original function may be damaged due to bubbles mixed when the ink is injected. For this reason, a re-use may be impossible.

In particular, when the bubbles floating in the injected ink are stuck to the surface of a sensor of the ink residual quantity detecting mechanism, the stuck bubbles may cause a change in residual vibration. Accordingly, whether the ink is present or not are not accurately detected, and thus it may be erroneously detected that the liquid level of the ink falls.

### SUMMARY

An advantage of some aspects of the invention is to provide a method of injecting a liquid into a liquid container into which the liquid can be injected without damage to a primary function of the liquid container, and the liquid container. The advantage can be attained by at least one of the following aspects:

A first aspect of the invention provides a method of injecting a liquid into a liquid container detachably mounted on a liquid consuming device, the liquid container comprising; a liquid containing portion; a liquid supply portion connectable to the liquid consuming device; a liquid guide passage for guiding the liquid contained in the liquid containing portion to the liquid supply portion; an air communicating passage communicating the liquid containing portion with an air; a first inner wall surface; and a second inner wall surface intersecting with the first inner wall surface, the first inner wall surface having a liquid containing portion outlet formed close to the second inner wall surface and allowing the liquid containing portion to communicate with the liquid guide passage, the method comprising: forming an injection port communicating with the liquid containing portion in the air communicating passage; injecting a predetermined amount of liquid through the injection port; and sealing the injection port after injecting the liquid.

A second aspect of the invention provides a method of injecting a liquid into a liquid container detachably mounted on a liquid consuming device, the liquid container comprising: a liquid containing portion; a liquid supply portion connectable to the liquid consuming device; a liquid guide passage for guiding the liquid contained in the liquid containing portion to the liquid supply portion; an air communicating passage communicating the liquid containing portion with an air; a first inner wall surface; and a pair of inner wall surfaces opposed to each other so as to intersect the first inner wall surface, the first inner wall surface having a liquid containing portion outlet formed between the pair of the inner wall surfaces so as to allow the liquid containing portion to communicate with the liquid guide passage, the method comprising the steps of; forming an injection port communicating with the liquid containing portion in the air communicating passage; injecting a predetermined amount of liquid through the injection port; and sealing the injection port after injecting the liquid.

According to the liquid injecting method in the above-described configuration, a process performed to inject the liquid into the container body includes the steps of opening the injection port for injecting the liquid, injecting the liquid, and sealing the injection port, which are all simple. When the liquid is injected into the used liquid container, a process performed in the container body may be small and it is possible to inject the liquid without damaging various functions of the liquid container. As a result, the used liquid container can be used at a low price.

The liquid injection method may preferably further comprise depressurizing an inside of the liquid containing chamber before injecting the liquid.

In addition, the inside of the liquid containing chamber may preferably depressurized through the liquid supply portion.

A third aspect of the invention provides a liquid container detachably mounted on a liquid consuming device, the liquid container comprising; a liquid containing portion; a liquid supply portion connectable to the liquid consuming device; a liquid guide passage for guiding the liquid contained in the liquid containing portion to the liquid supply portion; an air communicating passage communicating the liquid containing portion with an air; a first inner wall surface; and a second inner wall surface intersecting with the first inner wall surface, the first inner wall surface having a liquid containing portion outlet formed close to the second inner wall surface and allowing the liquid containing portion to communicate with the liquid guide passage, wherein an injection port communicating with the liquid containing portion is formed in the air communicating passage, a predetermined amount of liquid is injected through the injection port, and the injection port is sealed after injecting the liquid.

A fourth aspect of the invention provides a liquid container detachably mounted on a liquid consuming device, the liquid container comprising: a liquid containing portion; a liquid supply portion connectable to the liquid consuming device; a liquid guide passage for guiding the liquid contained in the liquid containing portion to the liquid supply portion; an air communicating passage communicating the liquid containing portion with an air; a first inner wall surface; and a pair of inner wall surfaces opposed to each other so as to intersect the first inner wall surface, the first inner wall surface having a liquid containing portion outlet formed between the pair of the inner wall surfaces so as to allow the liquid containing portion to communicate with the liquid guide passage, wherein an injection port communicating with the liquid containing portion is formed in the air communicating passage, a predetermined amount of liquid is injected through the injection port, and the injection port is sealed after injecting the liquid.

According to the liquid container with the above-described configuration, the liquid container refills with the liquid like a new manufactured liquid container, various functions of the liquid container can be performed like the new manufactured unused liquid container. Moreover, it is convenient to use the liquid container in the same way as the new manufactured unused liquid container. As a result, since an expected life span of the liquid container becomes longer, the resources can be saved and the environmental pollution can be prevented.

Further, since the liquid container can be provided at a low cost, a running cost of the liquid consuming device can be reduced.

In the liquid container with the above-described configuration, the liquid containing portion outlet may be provided in a more inner area than a meniscus formed on a corner between the first inner wall surface and the second inner wall surface by the liquid contained in the liquid containing portion.

According to such a configuration, the liquid containing portion outlet is disposed in the inner side of the meniscus formed in a different shape/size at the corner owing to a characteristics (particularly, viscosity or the like) of the liquid contained in the liquid containing portion. As a result, since the liquid gathering at the corner due to a surface tension is reliably extracted, an optimal discharging effect of the liquid can be achieved according to the contained liquid.

In the liquid container with the above-described configuration, an opposed wall may be provided on an upstream side of an inflow liquid of the liquid containing portion outlet with a liquid inflow gap therebetween.

According to such a configuration, even when the container body is detached from the liquid consuming device during the period of using the container body and air and a shake of the liquid containing portion by hands causes the gas and the liquid in the liquid containing portion to be stirred, most of the air and the liquid floating due to the stirring collide with the opposed wall, and thus the collision reduces a direct impact on the liquid containing portion outlet. As a result, the bubbles can be effectively prevented from leaking through the liquid containing portion outlet.

In the liquid container with the above-described configuration, the first inner wall surface may be a bottom surface of the liquid containing portion when the liquid consuming device is mounted in the container body.

According to such a configuration, since the first inner wall surface is the bottom surface of the liquid containing portion, the first inner wall surface is a surface in which the residual ink is most likely to remain. Accordingly, the last residual ink can be guided to the liquid containing portion outlet, thereby improving an ability to extract the residual ink. Moreover, an ability to discharge the liquid can be improved.

In the liquid container with the above-described configuration, the liquid containing portion outlet may be so a small round hole that a meniscus can be formed by the liquid contained in the liquid containing portion.

According to such a configuration, even when the surface tension forms a strong meniscus in the liquid containing portion outlet, the residual ink in the liquid containing portion decreases, and a shake of the liquid containing portion by hands causes the gas and the liquid in the liquid containing portion to be stirred, the meniscus formed in the liquid containing portion outlet serves as a barrier wall. As a result, the bubbles can be prevented from leaking through the liquid containing portion outlet.

In the liquid container with the above-described configuration, the liquid guide passage may be provided with a liquid detector for detecting that the liquid contained in the liquid containing portion is exhausted by sensing the inflow air into the liquid guide passage.

According to such a configuration, when the liquid detector is provided in the liquid guide passage, a non-discharging of the liquid or an erroneous detection during the period of using the liquid container due to the bubbles can be prevented. As a result, a detection precision of the liquid detector can be improved.

A fifth aspect of the invention provides a liquid container detachably mounted on a liquid consuming device, the liquid container comprising; a liquid containing portion; a liquid supply portion connectable to the liquid consuming device; a liquid guide passage communicating the liquid containing portion and the liquid supply portion with each other; an air communicating passage communicating the liquid containing portion with an air; a first inner wall surface; a second inner wall surface intersecting with the first inner wall surface, the first inner wall surface having a liquid containing portion outlet formed close to the second inner wall surface and allowing the liquid containing portion to communicate with the liquid guide passage; a film member forming at least apart of the air communicating path; and a sealing portion at which an injection port communicated with the liquid containing portion and formed on the film member is sealed.

A sixth aspect of the invention provides a liquid container detachably mounted on a liquid consuming device, the liquid container comprising; a liquid containing portion; a liquid supply portion connectable to the liquid consuming device; a liquid guide passage communicating the liquid containing portion and the liquid supply portion with each other; an air communicating passage communicating the liquid containing portion with an air; a first inner wall surface; and a pair of inner wall surfaces opposed to each other so as to intersect the first inner wall surface, the first inner wall surface having a liquid containing portion outlet formed between the pair of the inner wall surfaces so as to allow the liquid containing portion to communicate with the liquid guide passage; a film member forming at least a part of the air communicating path; and a sealing portion at which an injection port communicated with the liquid containing portion and formed on the film member is sealed.

In the liquid container, the sealing portion may be formed by a film or a tape.

### BRIEF DESCRIPTION OF THE DRAWINGS

The invention will be described with reference to the accompanying drawings, wherein like numbers reference like elements.

FIG. 1 is an exterior perspective view illustrating an ink cartridge which is an example of a liquid container according to an exemplary embodiment of the invention.

FIG. 2 is an exterior perspective view illustrating the ink cartridge according to the exemplary embodiment of the invention when viewed at an inverse angle in FIG. 1.

FIG. 3 is an exploded perspective view illustrating the ink cartridge according to the exemplary embodiment of the invention.

FIG. 4 is an exploded perspective view illustrating the ink cartridge according to the exemplary embodiment of the invention when viewed at an inverse angle in FIG. 3.

FIG. 5 is a diagram showing the ink cartridge according to the exemplary embodiment of the invention is mounted on a carriage of the ink jet printing apparatus.

FIG. 6 is a sectional view illustrating the ink cartridge according to the exemplary embodiment of the invention immediately before the ink cartridge is mounted on the carriage.

FIG. 7 is a sectional view illustrating the ink cartridge according to the exemplary embodiment of the invention immediately after the ink cartridge is mounted on the carriage.

FIG. 8 is a diagram illustrating the cartridge body of the ink cartridge according to the exemplary embodiment of the invention when viewed from the front surface.

FIG. 9 is a diagram illustrating the cartridge body of the ink cartridge according to the exemplary embodiment of the invention when viewed from the rear.

FIGS. 10(a) and 10(b) are schematic diagrams of the FIG. 8 and the FIG. 9, respectively.

FIG. 11 is a sectional view illustrating the cartridge body taken along the line A-A of FIG. 8.

FIG. 12 is an enlarged perspective view illustrating a part of a configuration of a flow passage in the cartridge body shown in FIG. 8.

FIG. 13 an enlarged perspective view illustrating major portions of the liquid container shown in FIG. 8.

FIG. 14 is an enlarged sectional view illustrating the major portions of the liquid container shown in FIG. 13

FIG. 15 is a sectional perspective view taken along the line V-V shown in FIG. 14.

FIG. 16 is an enlarged sectional view illustrating the vicinity of a liquid containing portion outlet shown in FIG. 14.

FIG. 17 is a sectional view illustrating a modified example in which a second inner wall surface intersects at an acute angle to a first inner wall surface.

FIG. 18 is a sectional view illustrating a modified example in which the liquid containing portion outlet is provided on a side wall.

FIG. 19 is a block diagram illustrating a configuration of an ink re-filling apparatus by which a method of injecting a liquid into an ink container according to the exemplary embodiment of the invention is performed.

### DESCRIPTION OF EXEMPLARY EMBODIMENTS

Hereinafter, a liquid injecting method and a liquid container according to an exemplary embodiment of the invention will be described in detail with reference to drawings. In the exemplary embodiment described below, as an exemplified liquid container, an ink cartridge mounted on an ink jet printing apparatus (printer), which is an example of a liquid ejecting apparatus, will be described.

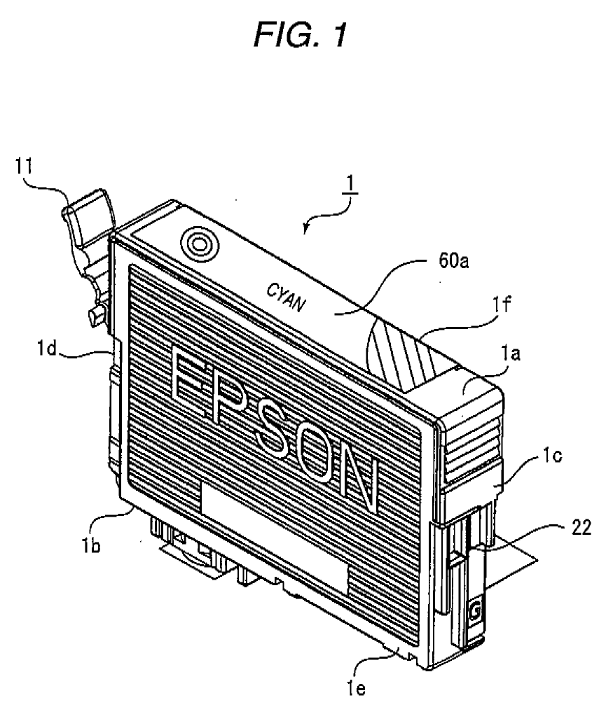

FIG. 1 is an exterior perspective view illustrating the ink cartridge which is an example of the liquid container according to an exemplary embodiment of the invention.

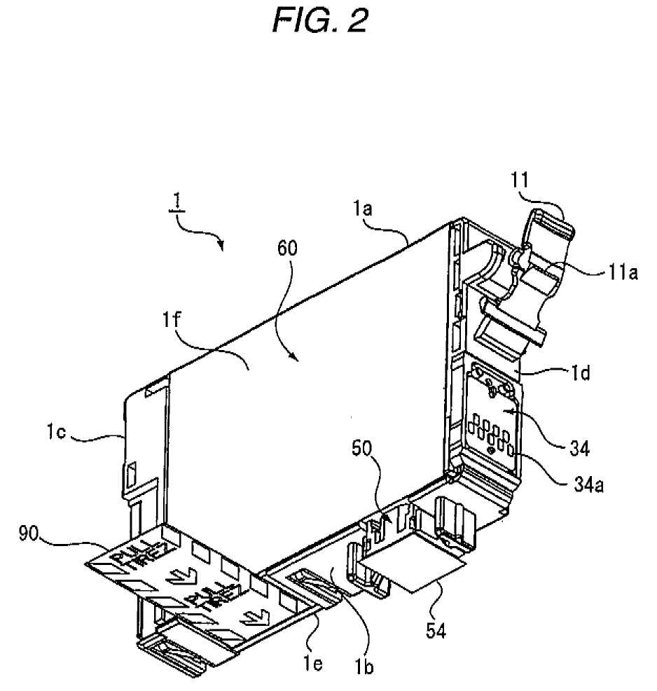

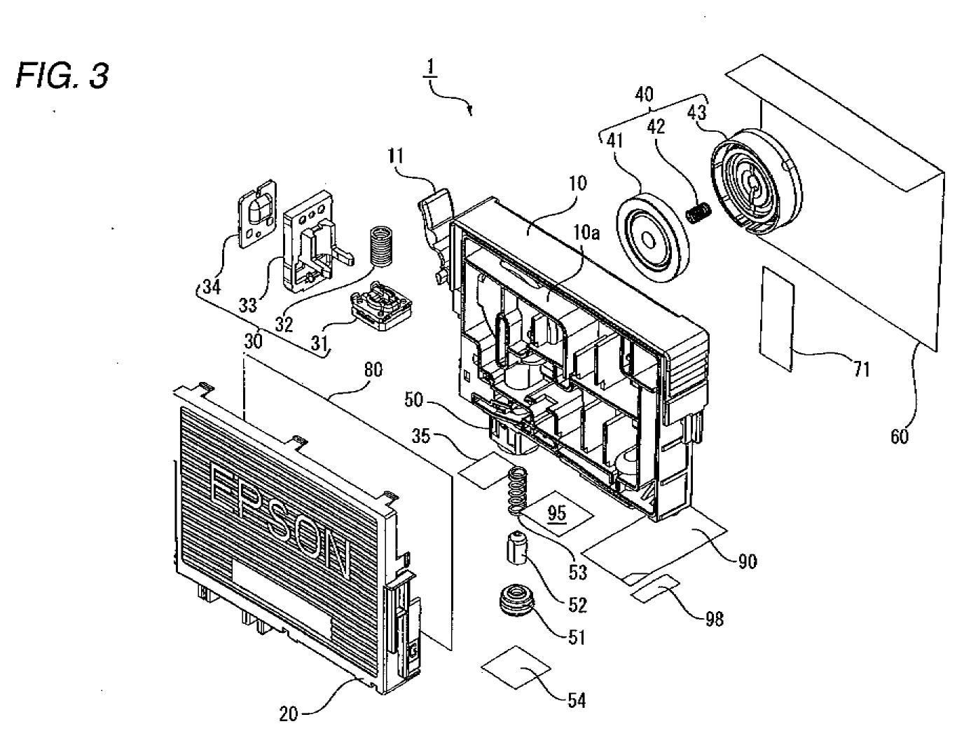

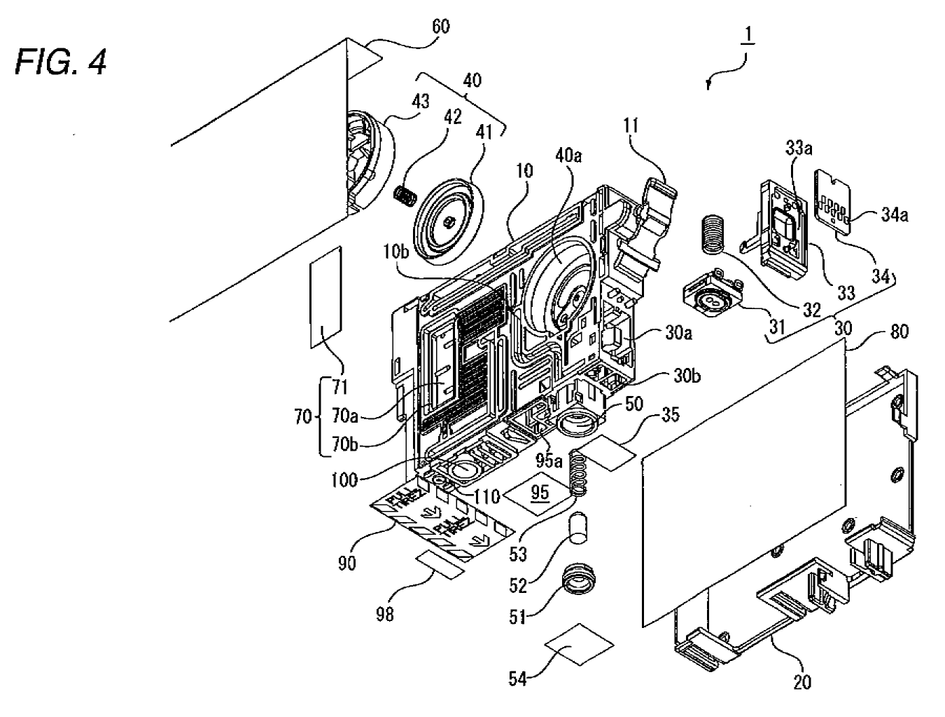

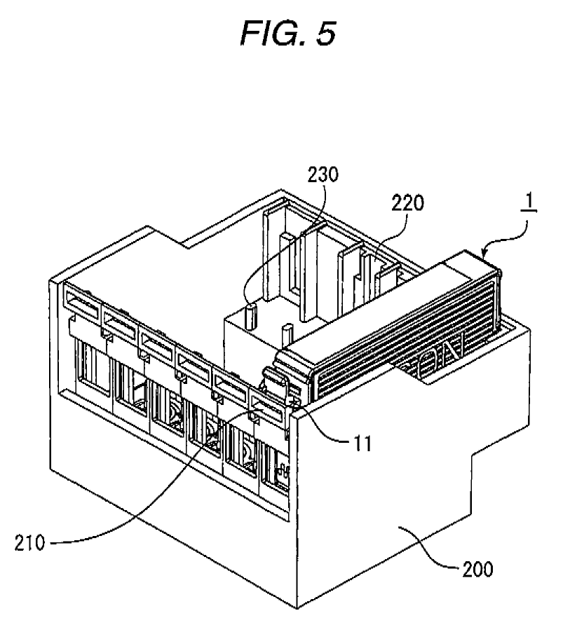

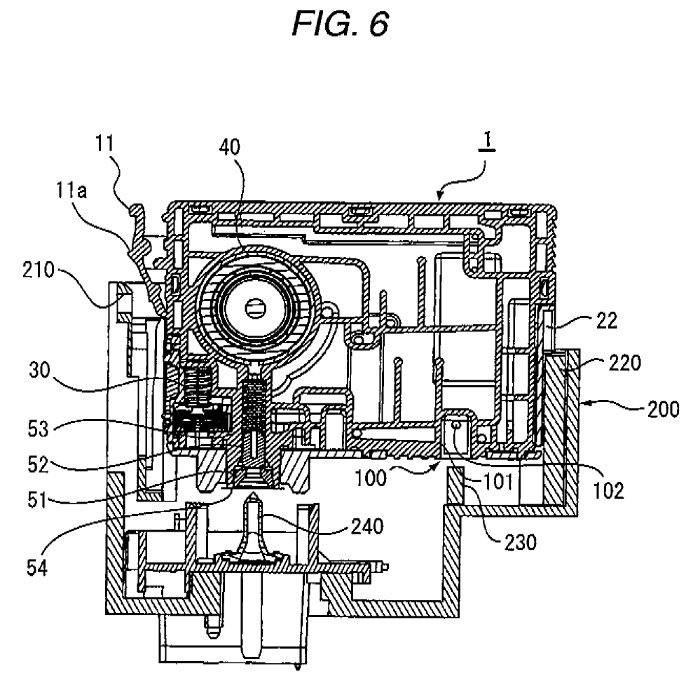

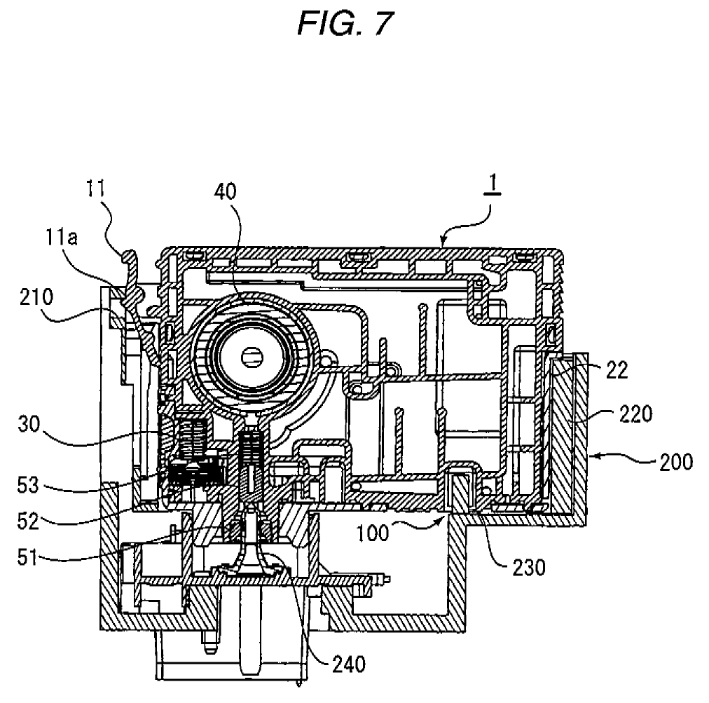

FIG. 2 is an exterior perspective view illustrating the ink cartridge according to the exemplary embodiment when viewed at an inverse angle in FIG. 1. FIG. 3 is an exploded perspective view illustrating the ink cartridge according to the exemplary embodiment. FIG. 4 is an exploded perspective view illustrating the ink cartridge according to the exemplary embodiment when viewed at an inverse angle in FIG. 3. FIG. 5 is a view illustrating when the ink cartridge according to the exemplary embodiment is mounted on a carriage. FIG. 6 is a sectional view illustrating the ink cartridge immediately before the ink cartridge is mounted on the carriage. FIG. 7 is a sectional view illustrating the ink cartridge immediately after the ink cartridge is mounted on the carriage.

As shown in FIGS. 1 and 2, an ink cartridge 1 according to the exemplary embodiment has a substantially rectangular parallelepiped shape and is the liquid container for storing/containing ink (liquid) I in an ink containing chamber (liquid containing portion) that is provided therein. The ink cartridge 1 is mounted on a carriage 200 of an ink jet printing apparatus that is an example of a liquid consuming device so as to supply the ink to the ink jet printing apparatus (see FIG. 5).

An outer appearance of the ink cartridge 1 will be described. As shown in FIGS. 1 and 2, the ink cartridge 1 has a flat upper surface 1a, and an ink supply portion (liquid supply portion) 50 that is connected to the ink jet printing apparatus to supply the ink is provide on a bottom surface 1b that is opposite to the upper surface la. Further, an air introducing hole 100 that communicates with the inside of the ink cartridge 1 for introducing air into the ink cartridge 1 opens in the bottom surface 1b.

That is, the ink cartridge 1 serves as an ink cartridge of an open-air type that provides ink from the ink supply portion 50 while introducing the air from the air introducing hole 100.

In the exemplary embodiment, the air introducing hole 100, as shown in FIG. 6, has a substantially cylindrical concave portion 101 that opens from the bottom surface toward the upper surface in the bottom surface 1b and a small hole 102 that opens in the inner circumference surface of the concave portion 101. Since the small hole 102 communicates with an air communicating path described below, the air is introduced into an upper ink containing chamber 370 (described below) positioned on an uppermost stream through the small hole 102.

The concave portion 101 of the air introducing hole 100 is formed in a position in which a protrusion 230 formed in the carriage 200 can be inserted. The protrusion 230 serves as a non-removing prevention protrusion for preventing a user from forgetting removal of a sealing film 90 that is means for air-tightly blocking the air introducing hole 100. That is, when the sealing film 90 is attached to the air introducing hole 100, the protrusion 230 cannot be inserted into the air introducing hole 100, and thus the ink cartridge 1 is not mounted on the carriage 200. Accordingly, even when a user tries to mount the ink cartridge 1 on the carriage 200 with the sealing film 90 attached to the air introducing hole 100, the ink cartridge 1 cannot be mounted. As a result, when the ink cartridge 1 is mounted, it is demanded that the sealing film 90 is reliably removed.

As shown in FIG. 1, an erroneous inserting prevention protrusion 22 for preventing the ink cartridge 1 from being mounted on an erroneous position is formed on a narrow side surface 1c adjacent to one end side of the upper surface 1a of the ink cartridge 1. As shown in FIG. 5, an uneven portion 220 corresponding to the erroneous inserting prevention protrusion 22 is formed on the carriage 200 which serves as a receiver. The ink cartridge 1 is mounted on the carriage 200 only when the erroneous inserting prevention protrusion 22 and the uneven portion 220 are not interfered with each other. The erroneous inserting prevention protrusion 22 has a different shape according to each kind of ink, and thus the uneven portion 220 on the carriage 200 which serves as the receiver has also a different shape according to the corresponding kind of ink. As a result, even when the plurality of ink cartridges is mounted on the carriage 200, as shown in FIG. 5, the ink cartridges may not be mounted on erroneous positions.

As shown in FIG. 2, an engagement lever 11 is provided on a narrow side surface 1d that is opposite to the narrow side surface 1c of the ink cartridge 1. A protrusion 11a that is engaged with a concave portion 210 formed in the carriage 200 when the ink cartridge 1 is mounted to the carriage 200 is formed in the engagement lever 11. Moreover, the protrusion 11a and the concave portion 210 are engaged with each other while the engagement lever 11 is bent so that the ink cartridge 1 is fixed on the carriage 200.

A circuit board 34 is provided below the engagement lever 11. A plurality of electrode terminals 34a are formed on the circuit board 34. Since the electrode terminals 34a comes in contact with an electrode member (not shown) provided in the carriage 200, the ink cartridge 1 is electrically connected with the ink jet printing apparatus. A nonvolatile memory capable of rewriting data is provided in the circuit board 34. Various data about the ink cartridge 1, ink use data of the ink jet printing apparatus, or the like are memorized in the nonvolatile memory. An ink residual quantity sensor 31 (liquid detection unit) used for detecting an amount of residual ink in the ink cartridge 1 using residual vibration is provided in the back of the circuit board 34 (see FIG. 3 or 4). Hereinafter, the ink residual quantity sensor 31 and the circuit board 34 are called an ink end sensor 30.

As shown in FIG. 1, a label 60a for denoting a content of an ink cartridge is attached to the upper surface 1a of the ink cartridge 1. The edge of an outer surface film 60 that covers a wide side surface 1f is extended and attached to the upper surface 1a so that the label 60a is formed.

As shown in FIGS. 1 and 2, the wide side surfaces 1e and 1f adjacent two long sides of the upper surface 1a of the ink cartridge 1 are formed in a flat surface shape. Hereinafter, a side of the wide side surface 1e, a side of the wide side surface 1f, a side of the narrow side surface 1c, and a side of the narrow side surface 1d denote a front side surface, a rear side surface, a right side surface, and a left side surface, respectively for convenience sake.

Next, each portion constituting the ink cartridge 1 will be described with reference to FIGS. 3 and 4.

The ink cartridge 1 has a cartridge body 10 that is the container body and a cover member 20 for covering the front side surface of the cartridge body 10.

Ribs 10a that have various shapes are formed in the front side surface of the cartridge body 10. In order to form walls, the ribs 10a partition a plurality of the ink containing chambers (liquid containing portion) that fill with the ink I, a non-containing chamber which does not fill with the ink I, an air chamber that is positioned in a way of the air communicating path 150 described below, and so on in the inside of the cartridge body 10.

A film 80 that covers the front side surface of the cartridge body 10 is provided between the cartridge body 10 and the cover member 20. The film 80 covers the upper surfaces of the ribs, concave portions, grooves so that a plurality of flow passages, the ink containing chambers, the non-containing chamber, the air chamber are formed.

In the rear side surface of the cartridge body 10, a concave-shaped differential pressure valve accommodating chamber 40a accommodating a differential pressure valve 40 and a concave-shaped gas-liquid separating chamber 70a constituting a gas-liquid separating filter 70 are formed.

A valve member 41, a spring 42, and a spring seat 43 are accommodated in the differential pressure valve accommodating chamber 40a and constitute the differential pressure valve 40. The differential pressure valve 40 is disposed between the ink supply portion 50 positioned on the downstream and the ink containing chamber positioned on the upstream, and is urged to a closed state in which the ink flow from a side of the ink containing chamber to a side of the ink supply portion 50 is blocked. The differential pressure valve 40 is configured so that when a differential pressure between the side of the ink containing chamber and the side of the ink supply portion 50 becomes a predetermined value or more depending on ink supply from the ink supply portion 50 to the printer, the differential valve 40 is changed from the closed state to the opened state and the ink I is supplied to the ink supply portion 50.

On the upper surface of the gas-liquid separating chamber 70a, a gas-liquid separating film 71 is attached along a dam 70b surrounding an outer circumference provided in the vicinity of the middle portion of the gas-liquid separating chamber 70a. The gas-liquid separating film 71 is made of a material that passes a gas, but does not pass a liquid. The gas-liquid separating film 71 constitutes the gas-liquid separating filter 70. The gas-liquid separating filter 70 is provided within the air communicating path 150 that connects the air introducing hole 100 to the ink containing chamber, and allows the ink I in the ink containing chamber not to leak to the air introducing hole 100 through the air communicating path 150.

In the rear side surface of the cartridge body 10, a plurality of grooves 10b are carved in addition to the differential pressure accommodating chamber 40a and the gas-liquid separating chamber 70a. Since the outer surface film 60 covers the outer surface in a state where the differential pressure valve 40 and the gas-liquid separating filter 70 are formed, the opening of each groove b is blocked, and thus the air communicating path 150 or the ink guide path (liquid guide path) is formed.

As shown in FIG. 4, a concave-shaped sensor chamber 30a that accommodates each member constituting the ink end sensor 30 is formed in the right side surface of the cartridge body 10. The ink residual quantity sensor 31 and a compressing spring 32 for pressing the residual quantity sensor 31 against the inner wall of the sensor chamber 30a are accommodated in the sensor chamber 30a. The opening of the sensor chamber 30a is covered with a cover member 33 so that the circuit board 34 is fixed on an outer surface 33a of the cover member 33. A sensing member of the ink residual quantity sensor 31 is connected to the circuit board 34.

The ink residual quantity sensor 31 includes a cavity forming a part of the ink guide path between the ink containing chamber and the ink supply portion 50, a vibrating plate forming apart of the wall surface of the cavity, and a piezo electric element (piezoelectric actuator) allowing vibration to be applied onto the vibrating plate. The ink residual quantity sensor 31 outputs residual vibration at the time of applying the vibration onto the vibrating plate to the printer as signals. Then the printer detects whether the ink I exists in the ink guide path from the signals output from the ink residual quantity sensor 31. The printer detects a difference in an amplitude, a frequency, or the like of the residual vibration between the ink I and the gas (bubble B mixed in the ink) based on the signals output from the ink residual quantity sensor 31 so as to detect whether the ink I exists in the cartridge body 10.

Specifically, when the ink I of the ink containing chamber in the cartridge body 10 is exhausted or is lowered to a predetermined amount, air introduced into the ink containing chamber passes through the ink guide path and enter into the cavity of the ink residual quantity sensor 31. At this time, the printer detects the change in the amplitude or the frequency of the residual vibration based on the signals output from the ink residual quantity sensor 31 and outputs an electrical signal for denoting the ink end or ink near end.

As shown in FIG. 4, a depressurization hole 110 used to depressurize the ink cartridge 1 by sucking air from the inside thereof by vacuuming means when the ink is injected, a concave portion 95a constituting the ink guide path from the ink containing chamber to the ink supply portion 50, and a buffer chamber 30b provided below the ink end sensor 30 are provided on the bottom surface of the cartridge body 10 in addition to the ink supply portion 50 and the air introducing hole 100 described above.

Immediately after the ink cartridge is manufactured, openings of the ink supply portion 50, the air introducing hole 100, the depressurization hole 110, the concave portion 95a, and the buffer chamber 30b are sealed by sealing films 54, 90, 98, 95, 35, respectively. The sealing film 90 for sealing the air introducing hole 100 is removed by a user before the ink cartridge is mounted on the ink jet printing apparatus to be used. Accordingly, the air introducing hole 100 is exposed to the outside so that the ink containing chamber in the ink cartridge 1 is allowed to communicate with open air by the air communicating path 150.

The sealing film 54 attached onto the outer surface of the ink supply portion 50, as shown in FIGS. 6 and 7, is configured so as to be torn by an ink supply needle 240 of the ink jet printing apparatus when mounted on the ink jet printing apparatus.

As shown in FIGS. 6 and 7, a ring-shaped sealing member 51 that is pressed against the outer surface of the ink supply needle 240 when mounted on a printer, a spring seat 52 that comes in contact with the sealing member 51 to block the ink supply portion 50 when not mounted on the printer, and a compressing spring 53 that urges the spring seat 52 in a direction of coming in contact with the sealing member 51 are included within the ink supply portion 50.

As shown in FIGS. 6 and 7, the ink supply needle 240 is inserted into the ink supply portion 50. At this time, the inner circumference of the sealing ember 51 and the outer circumference of the ink supply needle 240 are sealed with each other, a gap between the ink supply portion 50 and the ink supply needle 240 is sealed liquid-tightly. In addition, the front end of the ink supply needle 51 comes in contact with the spring seat 52 and pushes up the spring seat 52. At this time, since the spring seat 52 and the sealing member 51 are released from each other, the ink can be supplied from the ink supply portion 50 to the ink supply needle 240.

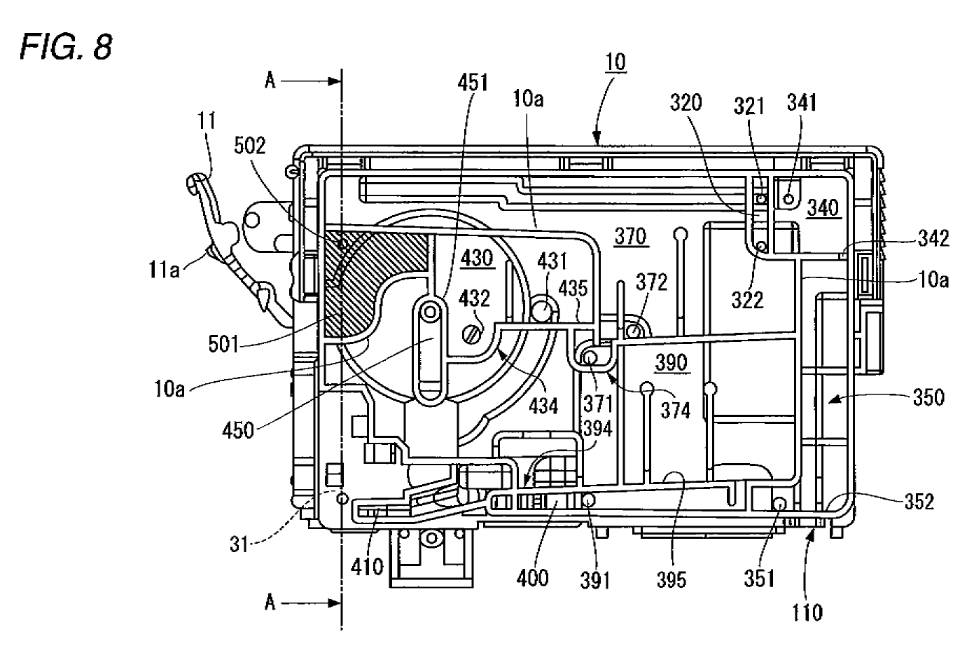

Next, the inner configuration of the ink cartridge 1 according to the exemplary embodiment will be described with reference to the FIGS. 8 to 12.

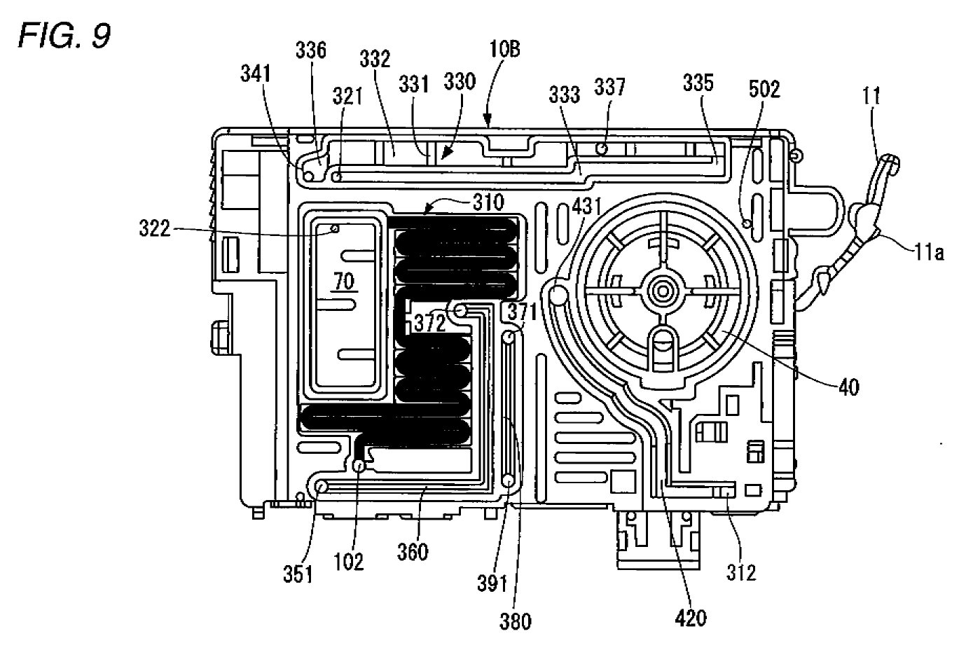

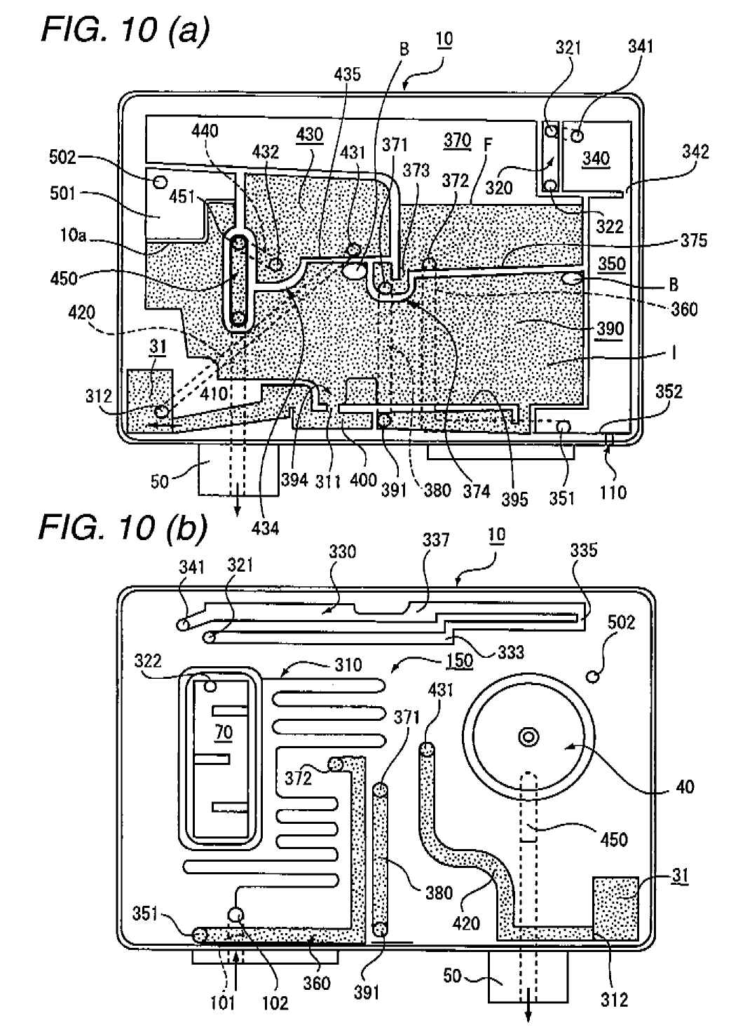

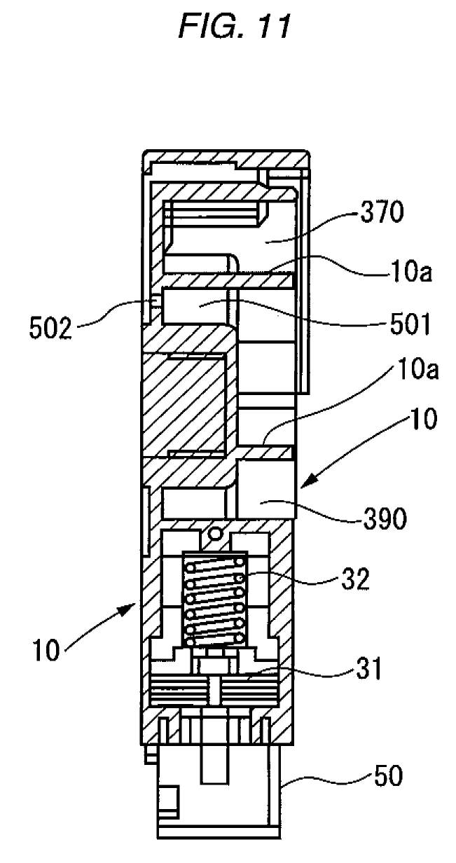

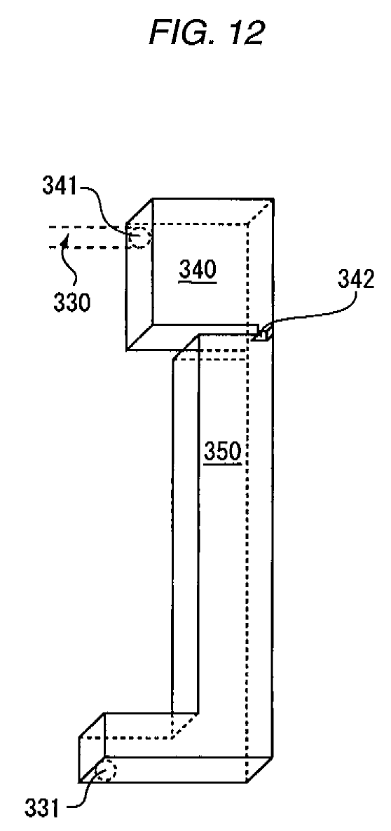

FIG. 8 is a diagram viewed from the front side surface of the cartridge body 10 of the ink cartridge 1 according to the exemplary embodiment. FIG. 9 is a diagram viewed from the rear side surface of the cartridge body 10 of the ink cartridge 1 according to the exemplary embodiment. FIG. 10(a) is a schematic diagram of the FIG. 8 and FIG. 10(b) is a schematic diagram of the FIG. 9. FIG. 11 is a sectional view taken along the line A-A of FIG. 8. FIG. 12 is a partly enlarged perspective view illustrating a flow passage shown in FIG. 8.

In the ink cartridge 1 according to the exemplary embodiment, three ink containing chambers, that is, the upper ink containing chamber 370 and a lower ink containing chamber 390 as primary ink containing chambers for filling with the ink I, and the buffer chamber 430 which is positioned so as to be interposed therebetween are formed in the front side surface of the cartridge body 10 (see FIG. 10).

Further, in the rear side surface of the cartridge body 10, the air communicating path 150 introducing air into the upper ink containing chamber 370, which is the ink containing chamber positioned on the uppermost stream, according to a consumption amount of the ink I, is formed.

The ink containing chambers 370 and 390 and the buffer chamber 430 are partitioned by a rib 10a. According to the exemplary embodiment, in each ink containing chamber, recesses 374, 394, and 434 having a caved-in shape downward are formed in a part of the rib 10a that horizontally extend so as to be bottom walls of the ink containing chambers.

The recess 374 is formed in the manner that a part of a bottom wall 375 formed by the rib 10a of the upper ink containing chamber 370 is caved in downward. The recess 394 is formed in the manner that a bottom wall 395 formed by the rib 10a of the lower ink containing chamber 390 and a bulge of the wall surface are caved in a thicknesswise direction of the cartridge. The recess 434 is formed in the manner that a part of a bottom wall 435 formed by the rib 10a of the buffer chamber 430 is caved in downward.

Moreover, ink discharging ports 371, 311, and 432 that communicate with the ink guide path 380, an upstream ink end sensor connecting flow passage 400, and an ink guide path 440 are provided in bottom portions or the vicinity of the recesses 374, 394, and 434, respectively.

The ink discharging ports 371 and 432 are through-holes that penetrates the wall surface of each ink containing chamber in the thicknesswise direction of the cartridge body 10. In addition, the ink discharging port 311 is a through-hole that penetrates the bottom wall 395 downward.

One end portion of the ink guide path 380 communicates with the ink discharging port 371 of the upper ink containing chamber 370 while the other end portion thereof communicates with an ink inflow port 391 provided in the lower ink containing chamber 390. In this way, the ink guide path 380 serves as a communicating flow passage for guiding the ink I contained in the upper ink containing chamber 370 to the lower ink containing chamber 390. The ink guide path 380 is provided so as to extend from the ink discharging port 371 of the upper ink containing chamber 370 vertically downward. Accordingly, the ink guide path 380 allows the pair of the ink containing chambers 370 and 390 to be connected with each other so that the ink I descends from upstream side to downstream side.

One end portion of the ink guide path 420 communicates with the ink discharging port 312 of the cavity of the ink residual quantity sensor 31 positioned on the downstream of the lower ink containing chamber 390 while the other end thereof communicates with an ink inflow port 431 provided in the buffer chamber 430. Accordingly, the ink guide path 420 guides the ink I contained in the lower ink containing chamber 390 to the buffer chamber 430. The ink guide path 420 is provided so as to extend obliquely upward from the ink discharging port 312 of the cavity in the ink residual quantity sensor 31. Accordingly, the ink guide path 420 allows the pair of the ink containing chambers 390 and 430 to be connected with each other so that the ink I ascends from upstream side to downstream side.

That is, in the cartridge body 10 according to the exemplary embodiment, the three ink containing chambers 370, 390, and 430 are allowed to be alternatively connected in series to each other so that the ink I descends or ascends.

The ink guide path 440 serves as an ink flow passage that allows the ink discharging port 432 of the buffer chamber 430 to guide the ink to a differential valve 40.

In this exemplary embodiment, the ink inflow ports 391 and 431 of the ink containing chambers are provided so as to be positioned above the ink discharging port 371 and 311 provided in the ink containing chambers and in the vicinities of the bottom walls 375, 395, and 435 of the ink containing chambers.

First, the ink guide path from the upper ink containing chamber 370, which is a primary ink containing chamber, to the ink supply portion 50 will be described below with reference to FIGS. 8 to 12.

The upper ink containing chamber 370 is an ink containing chamber positioned on the uppermost stream (the uppermost portion) in the cartridge body 10. As shown in FIG. 8, the upper ink containing chamber 370 is formed on the front side surface of the cartridge body 10. The upper ink containing chamber 370 occupies about the halt of an ink contained area of the ink containing chambers and is formed above the substantial half of the cartridge body 10.

The ink discharging port 371 that communicates with the ink guide path 380 opens in the recess 374 of the bottom wall 375 of the upper ink containing chamber 370. The ink discharging 371 is positioned below the bottom wall 375 of the upper ink containing chamber 370. Even when an ink level F within the upper ink containing chamber 370 falls up to the bottom wall 375, the ink discharging port 371 is positioned lower than the ink level F. Accordingly, the ink I continues to be stably discharged.

As shown in FIG. 9, the ink guide path 380 that is formed on the rear side surface of the cartridge body 10 allows the ink I to flow from the upper portion to the lower ink containing chamber 390.

The lower ink containing chamber 390 is an ink containing chamber into which the ink I stored in the upper ink containing chamber 370 is introduced. Moreover, as shown in FIG. 8, the lower ink containing chamber 390 occupies about the half of the ink contained area of the ink containing chambers formed on the front side surface of the cartridge body 10, and is formed below the substantial half of the cartridge body 10.

The ink inflow port 391 that communicates with the ink guide path 380 opens to a communicating flow passage disposed below the bottom wall 395 of the lower ink containing chamber 390. Accordingly, the ink I flows from the upper ink containing chamber 370 through the communicating flow passage.

An ink discharging port 311 that penetrates the bottom wall 395 allows the lower ink containing chamber 390 to communicate with the upstream ink end sensor connecting flow passage 400. A three-dimensional labyrinthine flow passage is formed in the upstream ink end sensor connecting flow passage 400. Accordingly, bubble B or the like that flow to the labyrinthine flow passage before the ink ends are caught so as not to flow toward the downstream.

The upstream ink end sensor connecting flow passage 400 communicates with a downstream ink end sensor connecting flow passage 410 through an ink inlet portion 427 that is a through-hole. Moreover, the ink I is guided to flow to the ink residual quantity sensor 31 through the downstream ink end sensor connecting flow passage 410.

The ink I guided to flow to the ink residual quantity sensor 31 is guided to flow from the ink discharging port 312, which is an outlet port of the cavity, to the ink guide path 420, which is formed on the rear side surface of the cartridge body 10, through the cavity (flow passage) within the liquid residual quantity sensor 31.

Since the ink guide path 420 is formed obliquely upward from the liquid residual quantity sensor 31 so as to allow the ink I to flow upward, the ink guide path 420 is connected to the ink inflow port 431 that communicates with the buffer chamber 430. Accordingly, the ink I that comes out of the ink residual quantity sensor 31 is guided to flow into the buffer chamber 430 through the ink guide path 420.

The buffer chamber 430 is a small room that is partitioned by the rib 10a between the upper ink containing chamber 370 and the lower ink containing chamber 390 and serves as a space for storing the ink immediately before the differential pressure valve 40. The buffer chamber 430 is formed so as to be opposite to the rear side of the differential pressure valve 40. Accordingly, the ink I flows to the differential pressure valve 40 through the ink guide path 440 that communicates with the ink discharging port 432 formed in the recess 434 of the buffer chamber 430.

The ink I that flows to the differential pressure valve 40 is guided to flow to the downstream by the differential pressure valve 40, and then is guided to an outlet flow passage 450 through a through hole 451. Since the outlet flow passage 450 communicates with the ink supply portion 50, the ink I is supplied to the ink jet printing apparatus through the ink supply needle 240 inserted into the ink supply portion 50.

As shown in FIGS., 13 and 14, a front chamber forming wall 523 is formed in a lower ink containing chamber 390. The front chamber forming wall 523 covers an ink discharging port (liquid containing portion outlet) 311 communicating with the ink inlet portion 427 of the downstream ink end sensor connecting passage 410. A notched opening 529 is formed in the front chamber forming wall 523 and the ink of the lower ink containing chamber 390 passes through the notched opening 529 and flows in a front chamber 531. The ink entering into the front chamber 531 passes through the ink discharging 311 to the ink inlet portion 427 through a labyrinthine flow passage 526. Subsequently, the ink flows to the ink inlet portion 427, the downstream ink end sensor connecting passage 410, and an ink inflow opening 423 (liquid inflow opening) r and passes through the liquid residual quantity sensor 31.

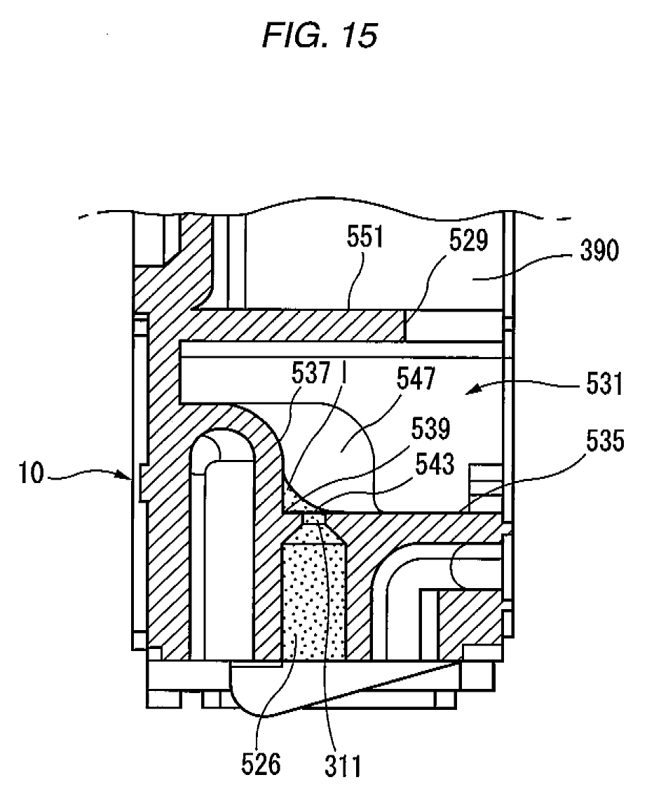

That is, the front chamber 531 constituting a part of the ink containing portion is provided in the lower ink containing chamber 390. As shown in FIG. 15, in the front chamber 531, a corner 539a is formed by a bottom surface 535 which is a first inner wall surface and a side wall surface which is a second inner wall surface intersecting the bottom surface 535. In addition, the ink discharging port 311 is formed through the bottom surface 535 in proximity with the side wall surface 537.

As shown in FIG. 15A, a specific formed position in which the ink discharging port 311 is formed through the bottom surface 535 in proximity with the side wall surface 537 is an area of the more inner area than a meniscus 543 formed at the corner 539 by the ink I contained in the lower ink containing chamber 390.

That is, when the amount of the ink decreases in the lower ink containing chamber 390, the remaining ink I gathers and a surface tension caused by a capillary phenomenon forms the meniscus 543 at the corner 539 between the bottom surface 535 and the side wall surface 537.

Since the ink discharging port 311 is disposed on the bottom surface 535 of an area which is in the more inner side than the meniscus 543 formed at the corner 539, the remaining ink I can be easily discharged to the downstream ink end sensor connecting passage 410 through the ink discharging port 311. When the ink I of the lower ink containing chamber 390 gradually decreases, a part of the meniscus 543 of the remaining ink I easily gathers so as to seal the ink discharging port 311. Accordingly, as long as the ink I exists in the lower ink containing chamber 390, it is difficult for air to firstly discharge through the ink discharging port 311.

In this way, since the ink discharging port 311 is disposed depending on a property of matter (particularly, viscosity or the like) of the ink contained in the lower ink containing chamber 390, the surface tension caused by the capillary phenomenon reliably extracts the ink I gathering at the corner 539. As a result, the ink I can be optimally discharged.

In the ink cartridge 1 according to the exemplary embodiment, the first inner wall surface is the bottom surface 535 of the lower ink containing chamber 390 when the container body 10 is mounted on the mounted portion of the ink cartridge of the ink jet printer. Further, the ink discharging port 311 is formed through the bottom surface 535 in which the amount of the residual ink is most likely to remain.

Accordingly, the last amount of the residual ink can be guided to the ink discharging port 311, and thus an ability to extract the residual ink can be improved. Further, an ability to discharge the residual ink can be improved.

Moreover, it is desirable that the ink discharging port 311 is so a small round hole that the meniscus is formed by the ink I contained in the lower ink containing chamber 390. Specifically, when the ink I having a general property of matter is used, the diameter thereof is about 0.8 mm. Since the round hole is formed in this way, the strong meniscus caused by the surface tension is formed in the ink discharging port 311 and the amount of the residual ink is reduced. Accordingly, the air and liquid are stirred in the lower ink containing chamber 390 due to the shake by hands, the meniscus formed in the ink discharging port 311 serves as the barrier wall. As a result, the bubble can be prevented from leaking through the ink discharging port 311.

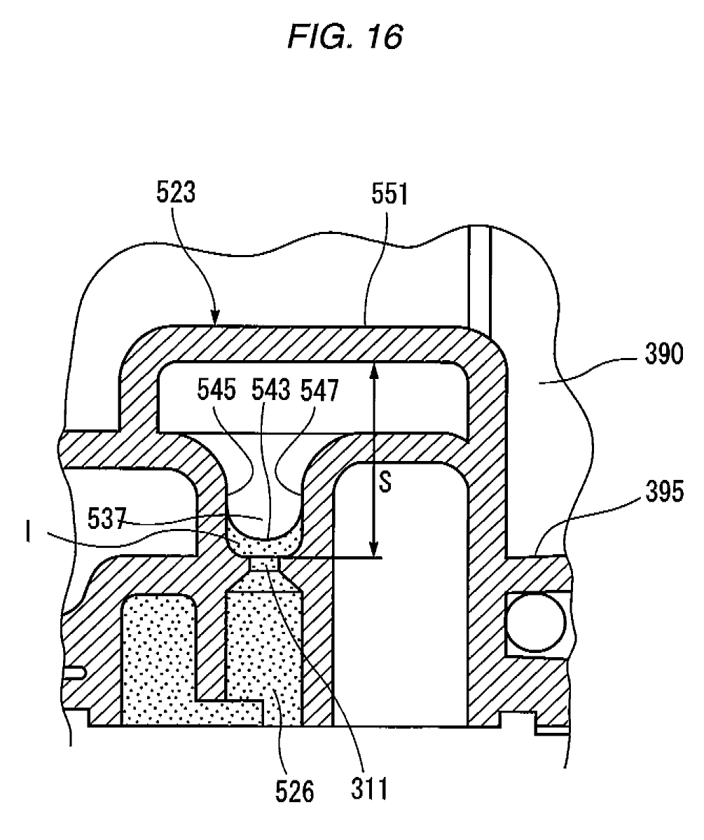

In the front chamber 531 of the ink cartridge 1 according to the exemplary embodiment, as shown in FIGS. 14 and 16, a pair of side wall surfaces (a pair of inner wall surfaces) 545 and 547 that intersect the bottom wall, which is the first inner wall surface, so as to be opposed to each other are provided. In addition, the ink discharging port 311 is formed through the bottom surface between the pair of the side wall surfaces 545 and 547.

Specifically, when the ink I of the general property of matter used, an interval between the pair of the side wall surfaces 545 and 547 is about 2 mm. In this way, since the pair of the side wall surfaces 545 and 547 are closely opposed to each other, the meniscus 543 can be easily formed between the pair of the side wall surface 545 and 547. In addition, it is easy for a part of the meniscus 543 of the ink I remaining in the lower ink containing chamber 390 to seal the ink discharging port 311 by the capillary phenomenon. That is, the amount of the residual ink can be further more easily discharged.

In the ink cartridge 1 according to the exemplary embodiment, as shown in FIG. 16, an opposed wall 551 is disposed on an upstream side of the an inflow liquid of an ink discharging port 311 with a liquid inflow gap S therebetween.

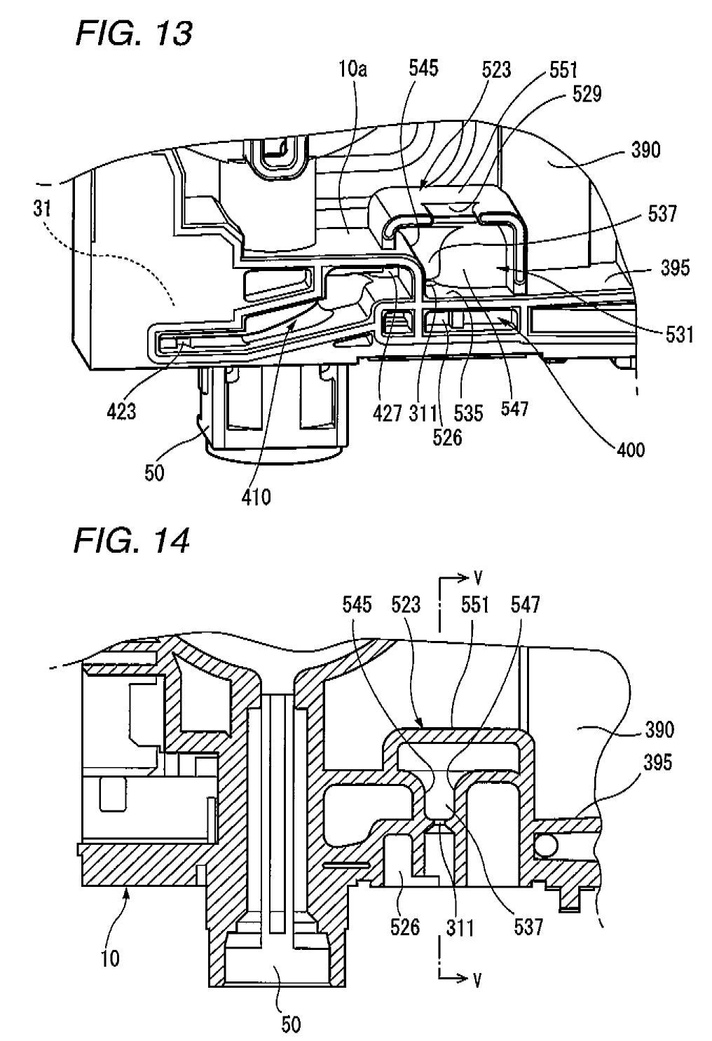

The opposed wall 551 can be configured as a part of the front chamber forming wall 523. That is, as shown in FIG. 13, a notched opening 529 of the front chamber forming wall 523 is disposed so as to deviate from the ink discharging port 311.

Accordingly, even when the container body 10 is attached to or detached from the ink jet printer during the period of the container body 10 is used and the air and liquid in the lower ink containing chamber 390 are stirred due to the shake by hands, most of the air and liquid that become fluid due to the stirring collide with the opposed wall 551. The collision contributes to a decrease in the direct impact on the ink discharging port 311. As a result, the bubbles can be effectively prevented from leaking.

In the ink cartridge 1, the ink discharging port 311 for allowing the lower ink containing chamber 390 to communicate with the downstream ink end sensor connecting passage 410 is formed through the bottom surface 535 surrounded by the side wall surface 537 intersecting the bottom surface 535 of the lower ink containing chamber 390 and the inner wall surfaces 545 and 547. Accordingly, as the ink I in the lower ink containing chamber 390 decreases, the surface tension caused by the capillary phenomenon enables the ink I to easily gather in the vicinity of the ink discharging port 311 surrounded by the side wall surface 537 and the inner wall surfaces 545 and 547.

For this reason, the ink I remaining in the lower ink containing chamber 390 easily discharges into the downstream ink end sensor connecting passage 410 through the ink discharging port 311. In addition, when the ink in the lower ink containing chamber 390 gradually decreases, the ink I easily gather so that a part of the meniscus 543 formed by the remaining ink I seals the ink discharging port 311. Accordingly, as long as the ink I remains in the lower ink containing chamber 390, it is difficult for air to firstly discharge through the ink discharging port 311.

In this way, the ink I rarely remains in the cartridge 1 and the air in the lower ink containing chamber 390 rarely enter into the downstream side. As a result, an ability to discharge the ink in the ink cartridge 1 and an ability to repress the bubble outflow can be improved.

In the above-describe configuration, the ink cartridge 1 includes the liquid residual quantity sensor 31 used for detecting that the ink in the lower ink containing chamber 390 is exhausted or is lowered to the predetermined amount, by sensing the air inflow into the downstream ink end sensor connecting passage 410. In this case, after the printer detect the ink end, the large amount of the residual ink in the lower ink containing chamber 390 can be prevented from remaining in view of a poor ink discharge. In addition, an erroneous detection of the printer due to the bubbles at the time of using the ink cartridge can be prevented. As a result, a detection precision of the liquid residual quantity sensor 31 can be improved.

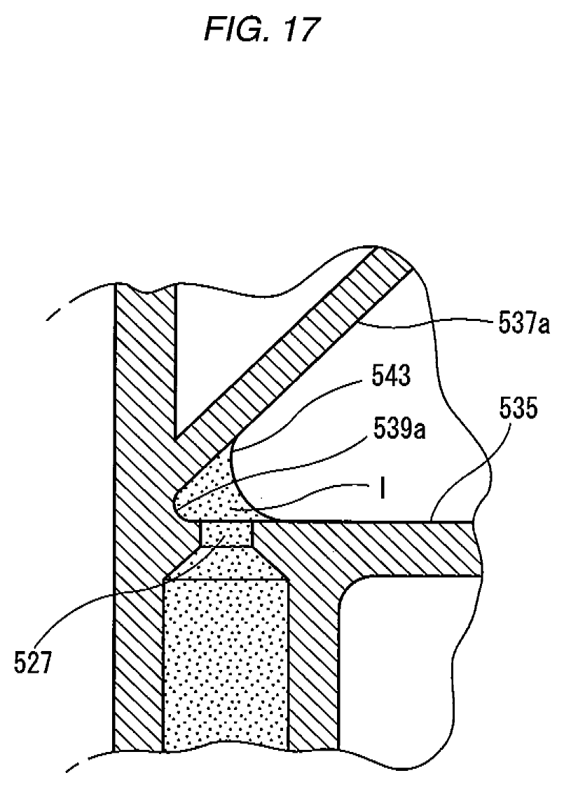

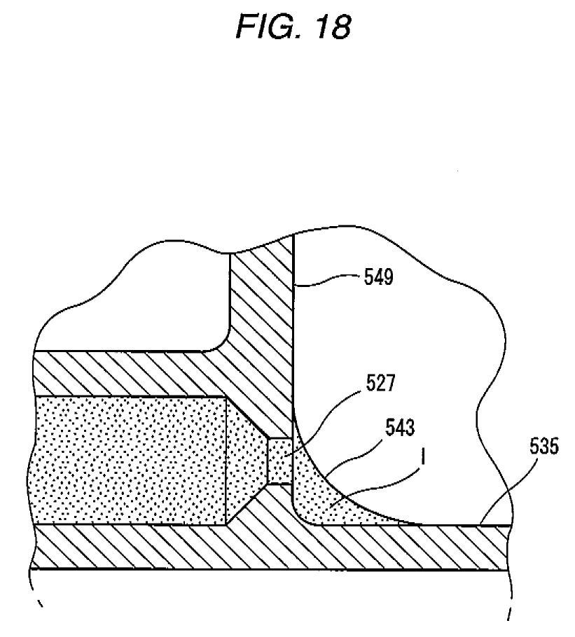

According to the above-described exemplary embodiment, the exemplary case where the bottom surface 535 intersects the side wall surface 537 at right angles is described. However, as shown in FIG. 17, the bottom surface 535 may be configured so as to intersect the side wall surface 537a at an acute angle and a corner 539a may be formed at the acute angle.

At this timer since the corner 539a is formed at the acute angle, the stronger surface tension gathers the remaining ink I in the corner 539a formed between the bottom surface 535 and the side wall surface 537a, thereby forming the meniscus 543.

In the ink cartridge 1 according to the exemplary embodiment, the bottom surface 535 is configured as the first inner wall surface and the ink discharging port 311 is formed there through. However, as shown in FIG. 18, the side wall surface 549 may be configured as the first inner wall surface and the ink discharging port 311 may be formed therethrough. Further, the bottom surface 535 may be configured as the second inner wall surface intersecting the side wall surface 549.

In this case, it is possible to obtain the same good effects to discharge the ink and to repress the bubble outflow as those obtained in the configuration according to the exemplary embodiment in which the ink discharging port 311 is formed through the bottom surface 535. Besides, when the inner space of the lower ink containing chamber 390 is configured as a flat space extending upward and downward (that is, which is wide in a height direction and narrow in a width direction as shown in FIG. 2), the ink discharging port 311 is provided on the sidewall surface 549 forming the flat space, by configuring the first inner surface as the bottom surface 535.

That is, the ink discharging port 311 is opened on the side wall surface 549 in the width direction in which the impact caused by the stirring rarely knock. As a result, even when the container body 10 is stirred by hands, the bubbles are further prevented from leaking.

Next, the air communicating path 150 from the air introducing hole 100 to the upper ink containing chamber 370 will be described with reference to FIGS. 8 to 12.

When an inner pressure of the ink cartridge 1 is reduced with a consumption of the ink I in the ink cartridge 1, air (gas) flows from the air introducing hole 100 to the upper ink containing chamber 370 as much as a reduction amount of the stored ink I.

A small hole 102 that is provided in the air introducing hole 100 communicates with an one end of a meandering passage 310 formed on the rear side surface of the cartridge body 10. The meandering passage 310 is a meandering path that is formed lengthwise, and extends from the air introducing hole 100 to the upper ink containing chamber 370 to prevent moisture of ink from evaporating. Further, the other end thereof is connected to the gas-liquid separating filter 70.

A through-hole 322 is formed on a bottom surface of the gas-liquid separating chamber 70a that constitutes the gas-liquid separating filter 70, and communicates with a space 320 formed on the front side surface of the cartridge body 10 through the through-hole 322.

In the gas-liquid separating filter 70, the gas-liquid separating film 71 is disposed between the through-hole 322 and the other end of the meandering passage 310. The gas-liquid separating film 71 has a meshed shape and is made of a textile material that has a high water repellent property and high oil repellent property.

The space 320 is formed on the right upper portion of the upper ink containing chamber 370 when viewed from the front side surface of the cartridge body 10. In the space 320, a through-hole 321 opens above the through-hole 322. The space 320 communicates with an upper connection flow passage 330 formed on the rear side surface through the through-hole 321.

The upper connection flow passage 330 has partial flow passages 333 and 337. The partial flow passage 333 extends from the through-hole 321 along the long side in the right direction, when viewed from the rear side surface so as to pass through the uppermost surface of the ink cartridge 1, that is, the uppermost portion from the gravity direction in a state where the ink cartridge 1 is mounted. The partial flow passage 337 reverses in a reverse portion 335 at the vicinity of the short side, passes through the upper surface of the ink cartridge 1, and extends up to a through-hole 341 formed at the vicinity of the through-hole 321. Further, the through-hole 341 communicates with the ink trap chamber 340 formed on the front side surface.

When the upper connection flow passage 330 is viewed from the rear side surface, a position 336 in which the through-hole 341 is formed and a concave portion 332 which is caved more deeply than the position 336 in the thicknesswise direction of the ink cartridge are provided in the partial flow passage 337 that extends from the reverse portion 335 to the through-hole 341. A plurality of ribs 331 are formed so that the concave portion 332 is partitioned. The partial flow passage 333 that extends from the through-hole 321 to the reverse portion 335 is formed so as to be shallower than the partial flow passage 337 that extends the reverse portion 335 to the through-hole 341.

In the exemplary embodiment, since the upper connection flow passage 330 is formed in the uppermost portion from the gravity direction, the ink I does not normally flow to the air introducing hole 100 beyond the upper connection flow passage 330. Moreover, the upper connection flow passage 330 has as a sufficiently wide thickness much as the ink I does not flow backward by the capillary phenomenon, and the concave portion 332 is formed in the partial flow passage 337. Accordingly, it is easy to catch the ink I that flows backward.

The ink trap chamber 340 is a rectangular parallelepiped space that is formed in a corner of the right upper portion of the cartridge body 10 when viewed from the front side surface. As shown in FIG. 12, the through-hole 341 opens to the vicinity of an inner corner of the left upper portion of the ink trap chamber 340 when viewed from the front side surface. Further, in a front corner of the right lower portion of the ink trap chamber 340, a notch 342 is formed in the manner that a part of the rib 10a, which serves as a wall, is notched. Accordingly, the ink trap chamber 340 communicates with the connecting buffer chamber 350 through the notch 342.

The ink trap chamber 340 and the connecting buffer chamber 350 are air chambers that are provided so as to expand a capacity of the way of the air communicating path 150. For this reason, even when the ink I flows backward from the upper ink containing chamber 370, the ink I remains in the ink trap chamber 340 and the connecting buffer chamber 350 so that the ink I does not flow into the air introducing hole 100 any more. The detailed role of the ink trap chamber 340 and the connecting buffer chamber 350 will be described below.

The connecting buffer chamber 350 is a space that is formed below the ink trap chamber 340. A depressurization hole 110 for extracting air when ink is injected is provided on the bottom surface 352 of the connecting buffer chamber 350. The through-hole 351 opens in the thicknesswise direction in the vicinity of the bottom surface 352 and in the lower portion in the down most gravity direction when mounted on the ink jet printing apparatus. Accordingly, through the through-hole 351, the connecting buffer chamber 350 communicates with a connecting flow passage 360 formed on the rear side surface.

The connecting flow passage 360 extends in a middle upward direction when viewed from the rear side surface, and communicates with the upper ink containing chamber 370 through a through-hole 372 that is in the downstream end of the air communicating path 150 opening in the vicinity of the bottom wall of the upper ink containing chamber 370. The air communicating path 150 according to the exemplary embodiment is constituted from the air introducing hole 100 to the connecting flow passage 360. The connecting flow passage 360 is slimly formed so as not to form a meniscus and flow the ink backward.

In the ink cartridge 1 according to the exemplary embodiment, as shown in FIG. 8, the non-containing chamber 501 that does not contain the ink I is shown when viewed from the front side surface of the cartridge body 10 in addition to the above-described ink containing chambers (the upper ink containing chamber 370, the lower ink containing chamber 390, and the buffer chamber 430), the air chambers (the ink trap chamber 340 and the connecting buffer chamber 350), and the ink guide paths (the upstream ink end sensor connecting flow passage 400 and the downstream ink end sensor connecting flow passage 410).

When viewed from the front side surface of the cartridge body 10, the non-containing chamber 501 is partitioned in an area close to the hatched left side surface so as to be inserted between the upper ink containing chamber 370 and the lower ink containing chamber 390.

In addition, in the non-containing chamber 501, an air introducing hole 502 that passes through the rear side surface is provided at the left upper corner in the inner area thereof so as to communicate with open air through the air introducing hole 502.

When the ink cartridge 1 is depressurized and packed, the non-containing chamber 501 serves as a deaerating chamber in which a deaerating negative pressure is accumulated. Since an inner atmospheric pressure of the cartridge body 10 is maintained equal to or less than the prescribed value by a negative pressure suction force of the non-containing chamber 501 and the depressurized package, it is possible to supply the ink I that has dissolved air a little.

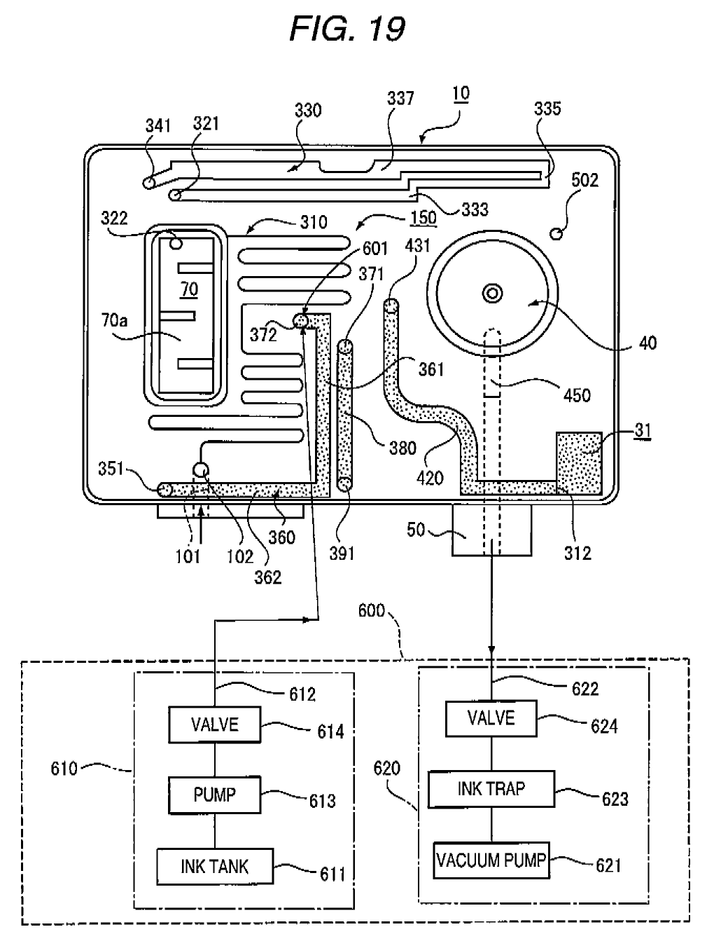

Next, when the ink I in the ink cartridge 1 described above is exhausted or is lowered to a predetermined value, a method of injecting the ink I into the used ink cartridge 1 according to an exemplary embodiment will be described with reference to FIG. 19.

First, a configuration of an ink re-injecting apparatus used for the injecting method according to the exemplary embodiment will be described.

As shown in FIG. 19, an ink re-injecting apparatus 600 includes an ink injecting mechanism 610 connected to an injection port 601, which is opened by a punching process in the ink cartridge 1, and a vacuum sucking mechanism 620 connected to the ink supply portion 50 of the cartridge body 10.

The ink injecting mechanism 610 includes an ink tank 611 for storing the filled ink I, a pump 613 for sending the ink I stored in the ink tank 611 to a flow passage 612 connected to the injection port 601, and a valve 614 for opening/closing the flow passage 612 between the pump 613 and the injection port 601.

The vacuum sucking mechanism 620 includes a vacuum pump 621 for generating a negative pressure required for the vacuum sucking; a connecting flow passage 622 for allowing the negative pressure generated by the vacuum pump 621 to apply to the ink supply portion 50; an ink trap 623 for being provided in the connecting flow passage 622, catching/collecting the ink I, which flows from the cartridge body 10 to the connecting flow passage 622 by the vacuum sucking, and protecting the vacuum pump 621 against ink mist or the like; and a valve 624 for opening/closing the connecting flow passage 622 between the ink trap 623 and the ink supply portion 50.

In the exemplary embodiment, in consideration of a configuration or a function of the ink cartridge 1, a position in which the injection port 601 communicating with the upper ink containing chamber 370 is formed in air communicating path 150 is determined in the vicinity of a position opposite to the through-hole 372 which is positioned in a downstream end of the connecting flow passage 360 constituting a part of the air communicating path 150.

The injection port 601 opposite to the through-hole 372 is bored through the outer surface film 60 (film member) covering 5 the rear side surface of the cartridge body 10 to conform with the through-hole 372. In the front end portion of the flow passage 612 inserted into the injection port 601, for example, a sealing member or the like for air-tightly allowing the flow passage 612 to connect to the through-hole 372 is provided by tightly pressing against the through-hole 372 and attaching to the wall surface of the circumference of the through-hole 372.

The injection port 601 communicating with the upper ink containing chamber 370 is formed in the air communicating path 150 positioned on more upstream than the upper ink containing chamber 370. The position on which the injection port 601 is formed is not limited to the exemplary embodiment.

For example, the injection port 601 may be formed by boring a hole through the outer surface film 60 so as to conform with the connecting flow passage 360 constituting a part of the air communicating path 150, or by peeling off the outer surface film 60. Alternatively, the injection port 601 may be formed by peeling off the outer surface film 60 and the gas-liquid separating film 71 so as to conform with the through-hole 322 opening to the gas-liquid separating chamber 70a constituting the gas-liquid separating filter 70.

Moreover, the injection port 601 may be formed by removing the cover member 20 from the ink cartridge 1, exposing the film 80 covering the front side surface of the cartridge body 10, and boring a hole through the film 80 so as to conform with the through-hole 351 that is positioned in the upper end of the connecting flow passage 360 constituting a part of the air communicating path 150.

According to the exemplary embodiment, the used ink cartridge 1 is recovered as a reusable ink cartridge (liquid container) by, first, an injecting forming step of forming the injection port 601 communicating with the upper ink containing chamber 370 in the air communicating path 150, a vacuum sucking step of sucking and removing the residual ink and residual air remaining in the inside from the ink supply portion 50 by the vacuum sucking mechanism 620, a liquid injecting step of injecting a predetermined amount of ink from the injection port 601 by the ink injecting mechanism 610, and a sealing step of sealing the injection port 601 after the liquid injecting step.

Specifically, the sealing step is a process of forming a sealing portion. Specifically, the injection port 601 is air-tightly closed by attaching or welding a sealing film, a tape or the like, or by putting a stopper or the like.

In the above-described ink injecting method of the ink cartridge according to the exemplary embodiment, a process of injecting the ink I into the ink cartridge 1 is performed by the step of opening the injection port 601 for injecting the ink I to the outer surface film 60 so as to communicate with the upper ink containing chamber 370, and the step of sealing the injection port 601 after injecting the ink I, which are all the simple steps. As a result, a processing cost can be reduced and it is not difficult to re-fill an ink cartridge.

In the exemplary embodiment, the vacuum sucking step of sucking and removing the residual ink and residual air remaining in the inside from the ink supply portion 50 is provided. As a result, when the liquid injecting step of injecting the predetermined amount of the ink I from the injection port 601 is performed, the ink guide paths 380, 420, and 440 or the ink containing chambers of the cartridge body 10 are controlled under the depressurization environment, and thus all the ink guide paths including the ink supply portion 50 as well as the ink containing chambers 370, 390, and 430 can effectively refill with the injected ink I.

The bubbles mixed at the time of injecting the ink I can be also extracted to the outside through the ink supply portion 50 by a vacuum sucking. Alternatively, the inflow bubbles can dissolve/disappear under a depressurization environment of the container by the vacuum sucking.

Accordingly, the bubbles mixed at the time of injecting the ink I does not float in the ink containing chambers or the ink guide passages or does not stick to the wall surfaces of the flow passage. For example, there is no occurrence that the liquid residual quantity sensor does not normally operate due to the remaining bubbles in the vicinity of the detector of the liquid residual quantity sensor.

That is, according to the above-described configuration, when the ink is injected into the used ink cartridge 1, a process in the cartridge body 10 is small. Moreover, the ink can be injected without damaging various functions of the ink cartridge 1 and the used ink cartridge 1 can be used at a low price.

When the refilled ink cartridge refilled by such an ink injecting method is provided, the expected life span of the product as an ink cartridge container is increased. As a result, the resource can be saved and the environmental pollution can be prevented. Further, since a cost required for the re-filling is inexpensive, and an ink cartridge is provide at a low price, a running cost for the ink jet printing apparatus can be reduced.

In addition, in the above-described ink injecting method of the ink cartridge according to the exemplary embodiment, a cleaning liquid can be injected in the cartridge body 10 from the injection port 601 to clean/remove coagulated ink in the inside of the container between the vacuum sucking step and the liquid injecting step. It is not required that the processing order of the vacuum sucking step and the liquid injecting step are definitely set. For example, while performing the vacuum sucking step, the liquid injecting step may be performed together.

The ink re-injecting apparatus 600 used to perform the ink injecting step according to the exemplary embodiment may be substituted by an apparatus that can be easily obtained.

For example, the ink injecting mechanism 610 may be substituted by an injecting apparatus constituted by a cylinder and a piston for a syringe, or may be substituted by a supplementary bottle containing supplementary ink in a deformable pet bottle.

In the liquid container according to the exemplary embodiment, the configuration of the container body, the liquid containing portion, the liquid supply portion, the liquid guide path, the air communicating path, the liquid detecting portion, the dam portion, and the like is not limited to the exemplary embodiment, but may be modified in various forms without departing from the gist of the invention.

A use of the liquid container according to the invention is not limited to the above-described ink cartridge of the ink jet printing apparatus. The liquid container can be applied to various liquid consuming apparatus including a liquid ejecting head ejecting a small amount of liquid drop, and the like.

Specific examples of the liquid consuming apparatus include an apparatus having a color material ejecting head used for manufacturing a color filter such as a liquid crystal display, an apparatus having an electrode material (conductive paste) ejecting head used for forming an electrode such as an organic EL display, or a field emission display (FED), an apparatus having a bioorganic matter ejecting head used for manufacturing a biochip, an apparatus having a simple ejecting head used for a precision pipette, a printing apparatus, a micro dispenser, and the like.

This application claims priority from Japanese Patent Application Nos. 2006-220772 filed on Aug. 12, 2006 and 2006-220755 filed on Aug. 11, 2006, the entire disclosure of which are expressly incorporated by reference herein.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the sprit and scope of the invention.

What is claimed is:

1. A method of injecting a liquid into a liquid container detachably mounted on a liquid consuming device, the liquid container comprising:
a liquid containing portion;
a liquid supply portion connectable to the liquid consuming device;
a liquid guide passage for guiding the liquid contained in the liquid containing portion to the liquid supply portion;
an air communicating passage communicating the liquid containing portion with an air;
a first inner wall surface; and
a second inner wall surface intersecting with the first inner wall surface, the first inner wall surface having a liquid containing portion outlet formed close to the second inner wall surface and allowing the liquid containing portion to communicate with the liquid guide passage, the method comprising;
forming an injection port communicating with the liquid containing portion in the air communicating passage;
injecting a predetermined amount of liquid through the injection port; and
sealing the injection port after injecting the liquid.

2. A method of injecting a liquid into a liquid container detachably mounted on a liquid consuming device, the liquid container comprising:
a liquid containing portion;
a liquid supply portion connectable to the liquid consuming device;
a liquid guide passage for guiding the liquid contained in the liquid containing portion to the liquid supply portion;
an air communicating passage communicating the liquid containing portion with an air;
a first inner wall surface; and
a pair of inner wall surfaces opposed to each other so as to intersect the first inner wall surface, the first inner wall surface having a liquid containing portion outlet formed between the pair of the inner wall surfaces so as to allow the liquid containing portion to communicate with the liquid guide passage, the method comprising the steps of:
forming an injection port communicating with the liquid containing portion in the air communicating passage;
injecting a predetermined amount of liquid through the injection port; and
sealing the injection port after injecting the liquid.

3. The method according to claim 1, further comprising depressurizing an inside of the liquid containing chamber before injecting the liquid.

4. The method according to claim 3, wherein the inside of the liquid containing chamber is depressurized through the liquid supply portion.

5. A liquid container detachably mounted on a liquid consuming device, the liquid container comprising:
a liquid containing portion;
a liquid supply portion connectable to the liquid consuming device;
a liquid guide passage for guiding the liquid contained in the liquid containing portion to the liquid supply portion;
an air communicating passage communicating the liquid containing portion with an air;
a first inner wall surface; and
a second inner wall surface intersecting with the first inner wall surface, the first inner wall surface having a liquid containing portion outlet formed close to the second inner wall surface and allowing the liquid containing portion to communicate with the liquid guide passage,
wherein an injection port communicating with the liquid containing portion is formed in the air communicating passage, a predetermined amount of liquid is injected through the injection port, and the injection port is sealed after injecting the liquid.

6. The liquid container according to claim 5, wherein the liquid containing portion outlet is provided in a more inner area than a meniscus formed on a corner between the first inner wall surface and the second inner wall surface by the liquid contained in the liquid containing portion.

7. A liquid container detachably mounted on a liquid consuming device, the liquid container comprising:
a liquid containing portion;
a liquid supply portion connectable to the liquid consuming device;
a liquid guide passage for guiding the liquid contained in the liquid containing portion to the liquid supply portion;
an air communicating passage communicating the liquid containing portion with an air;
a first inner wall surface; and
a pair of inner wall surfaces opposed to each other so as to intersect the first inner wall surface, the first inner wall surface having a liquid containing portion outlet formed between the pair of the inner wall surfaces so as to allow the liquid containing portion to communicate with the liquid guide passage,
wherein an injection port communicating with the liquid containing portion is formed in the air communicating passage, a predetermined amount of liquid is injected through the injection port, and the injection port is sealed after injecting the liquid.

8. The liquid container according to claim 7, wherein the liquid containing portion outlet is provided in an area of a meniscus formed between the pair of the inner wall surfaces by the liquid contained in the liquid containing portion.

9. The liquid container according to claim 5, wherein an opposed wall is provided on an upstream side of an inflow liquid of the liquid containing portion outlet with a liquid inflow gap therebetween.

10. The liquid container according to claim 5, wherein the first inner wall surface is a bottom surface of the liquid containing portion in a posture that the liquid container is mounted on the liquid consuming device.

11. The liquid container according to claim 5, wherein the liquid containing portion outlet is so a small round hole that a meniscus can be formed by the liquid contained in the liquid containing portion.

12. The liquid container according to claim 5, further comprising a liquid detecting unit for outputting different signals in accordance with a residual amount of the liquid in the liquid containing portion.

13. A liquid container detachably mounted on a liquid consuming device, the liquid container comprising:
a liquid containing portion;
a liquid supply portion connectable to the liquid consuming device;
a liquid guide passage communicating the liquid containing portion and the liquid supply portion with each other;
an air communicating passage communicating the liquid containing portion with an air;
a first inner wall surface;
a second inner wall surface intersecting with the first inner wall surface, the first inner wall surface having a liquid containing portion outlet formed close to the second inner wall surface and allowing the liquid containing portion to communicate with the liquid guide passage;
a film member forming at least a part of the air communicating path; and
a sealing portion at which an injection port communicated with the liquid containing portion and formed on the film member is sealed.

14. A liquid container detachably mounted on a liquid consuming device, the liquid container comprising:
a liquid containing portion;
a liquid supply portion connectable to the liquid consuming device;
a liquid guide passage communicating the liquid containing portion and the liquid supply portion with each other;
an air communicating passage communicating the liquid containing portion with an air;
a first inner wall surface; and
a pair of inner wall surfaces opposed to each other so as to intersect the first inner wall surface, the first inner wall surface having a liquid containing portion outlet formed between the pair of the inner wall surfaces so as to allow the liquid containing portion to communicate with the liquid guide passage;
a film member forming at least a part of the air communicating path; and
a sealing portion at which an injection port communicated with the liquid containing portion and formed on the film member is sealed.

15. The liquid container according to claim 13, wherein the sealing portion is formed by a film or a tape.
